(19) United States
(12) Patent Application Publication
(10) Pub. No.: US 2015/0099640 A1
(43) Pub. Date: Apr. 9, 2015

(54) COOLING CONTAINER

(71) Applicant: FURUKAWA ELECTRIC CO., LTD., Chiyoda-ku, Tokyo (JP)

(72) Inventors: Hajime Kasahara, Chiyoda-ku (JP); Taro Matsuoka, Chiyoda-ku (JP); Masakazu Matsui, Chiyoda-ku (JP)

(73) Assignee: FURUKAWA ELECTRIC CO., LTD., Chiyoda-ku, Tokyo (JP)

(21) Appl. No.: 14/403,376

(22) PCT Filed: Jan. 29, 2013
(86) PCT No.: PCT/JP2013/051807

§ 371 Date: Nov. 24, 2014

(30) Foreign Application Priority Data
May 29, 2012 (JP) 2012-121697

(51) Int. Cl. H01B 12/16; H01B 12/06; H01B 12/02

(52) U.S. Cl. CPC H01B 12/16; H01B 12/02; H01B 12/06
USPC 505/163; 361/699

(57) ABSTRACT

A cooling container accommodates an object to be cooled and a liquid coolant in the inside. A lid member can close an upper opening of the coolant container. A cooling device is supported by the lid member and includes a cooling section at a lower end. Electric current leads supported by the lid member make electric current flow into the object to be cooled inside the coolant container. The electric current leads each include a thermal resistance section with higher thermal resistance than surrounding portions, positioned above the liquid surface of the liquid coolant in the coolant container. Between the thermal resistance sections and the cooling section, a partition section made from a heat insulation material with a lower end below the thermal resistance sections is provided. An effect of penetrating heat can be prevented, allowing the inside of the coolant container to be efficiently cooled.

### TECHNICAL FIELD

The present invention relates to a cooling container that cools an object to be cooled in the container via a liquid coolant.

### BACKGROUND ART

Superconducting wires and superconducting films, which are made of a superconducting material such as an yttrium- or bismuth-based material, are used in the fields of superconducting magnet etc. which is a source of a strong magnetic field in SMES (superconducting magnetic energy storages), superconducting transformers, superconducting current limiting devices, and furthermore, NMR (nuclear magnetic resonance), semiconductor pullers, etc. To make such wires superconductive, it is required to cool them down to an ultralow temperature.

Superconducting wires are generally housed in a vacuum-insulated cooling container called cryostat in the form of a superconducting coil in order to cool them.

A conventional cryostat includes a coolant container in which a superconducting coil and a coolant are housed, a refrigerator to cool the coolant in the coolant container, and a pair of electric current leads to apply an electric current to the superconducting coil (e.g. see Patent Document 1).

It is essential in such cryostats to maintain the coolant in the coolant container at an ultralow temperature. However, since it is required to connect the superconducting coil in the cryostat to an external power supply via the electric current lead, a heat inevitably leaks in through the electric current lead that connects between the inside and the outside.

To cope with the problem, the electric current lead of conventional cryostats is partly formed in a coil shape outside the coolant container. This substantially extends the heat transfer path of the electric current lead so as to reduce the amount of heat to be transferred, and thereby reduces the heat leak.

Further, Patent Document 2 and Patent Document 3 disclose techniques for reducing a heat leak due to an electric current lead, in which a pipe is provided to house a lead body through which an electric current flows and an insulating member so that a channel is formed therein through which a coolant gas flows.

### PRIOR ART DOCUMENT

### Patent Document

Patent Document 1: JP H07-045420A
Patent Document 2: JP H09-092893A
Patent Document 3: JP H11-121222A

### SUMMARY OF INVENTION

### Problem to be Solved by the Invention

However, while the cryostat disclosed in Patent Document 1 can reduce the direct heat leak from the electric current lead to the coolant, it cannot reduce an influence of a heat leak from the electric current lead due to gas convection.

Further, the techniques of Patent Document 2 and Patent Document 3 for cooling an electric current lead require a device that sends the coolant gas to the channel in the electric current lead, which results in the complexity of the whole cryostat system and high cost and large size of the apparatus. While it would be also possible to feed the coolant gas from a coolant container to the channel of the electric current lead, this increases consumption of the coolant in the coolant container and therefore requires constant supply of the coolant.

It is an object of the present invention to provide a cooling container that performs effective cooling by means of a reduction of the influence of a heat leaked in the coolant container.

### Means for Solving the Problem

The invention comprises: a coolant container which houses an object to be cooled and a liquid coolant in an inner space; a lid member capable of closing an upper opening of the coolant container; a cooling unit which is supported by and hung from the lid member and which comprises a cooling section at a lower end; and an electric current lead which is supported by and hung from the lid member, and which applies an electric current to the object to be cooled in the inner space of the coolant container, wherein the electric current lead comprises a thermal resistance section which is disposed in the inner space of the coolant container at a level higher than a liquid level of the liquid coolant, and which has a thermal resistance higher than parts of the electric current lead above and below the thermal resistance section, and wherein a cooling container further comprises a partition section which is made of a heat insulating material, and which is disposed between the thermal resistance section and the cooling section of the cooling unit, in which a lower end of the partition section extends to a level lower than the thermal resistance section.

In the above configuration, a circumferential side of the thermal resistance section of the electric current lead and a part above the thermal resistance section may be covered.

In the above configuration, the partition section may cover a circumferential side of the cooling section of the refrigerator.

In the above configuration, the thermal resistance section may be constituted by a structure which has a reduced cross sectional area compared to the other part of the electric current lead.

In the above configuration, the thermal resistance section may be constituted by a portion in which separate conductor bodies are coupled with each other.

In the above configuration, the thermal resistance section may be constituted by a structure in which a conductive material having a thermal resistance higher than the other part of the electric current lead is interposed in the electric current lead.

### Effects of Invention

In the present invention, since the thermal resistance section is provided at some midpoint in the electric current lead, a leaked heat is less conducted to the part below the thermal resistance section. Without the thermal resistance section of the electric current lead, the temperature of the electric current lead gradually decreases at an approximately constant decreasing rate from the upper end of the electric current lead to the surface of the liquid coolant. In contrast, with the thermal resistance section, the temperature drastically changes at the thermal resistance section, which makes a certain temperature difference between the parts above and below the thermal resistance section.

Accordingly, the temperature of the coolant container becomes higher in the area above the thermal resistance section and lower in the area below the thermal resistance section. Further, the partition section that hangs down to a level lower than the thermal resistance section between the thermal resistance section and the cooling section of the cooling unit can reduce a heat leak from the electric current lead to the cooling unit due to convection of a high temperature coolant gas.

This can effectively reduce the influence of the heat leaked in the internal container of the coolant container on the cooling unit, and thereby reduce the required cooling performance by the amount required for cooling the heated coolant gas to a temperature near the boiling point thereof, which is heated by the heat leaked in the inner space of the cooling container through the electric current lead. As a result, it becomes possible to perform effective cooling even when a heat is leaked in through the electric current lead.

Further, when the partition section is configured to cover the part of the electric current lead at and above the thermal resistance section, it can isolate the coolant gas heated by the part of the electric current lead at and above the thermal resistance. That is, it can shield the cooling section from the heated coolant gas, which enables effective cooling.

When the partition section is configured to cover the circumferential side of the cooling section of the cooling unit, it can shield the cooling section from the coolant gas heated by the leaked heat that exists in the area above the lower end of the partition section, which enables effective cooling. The partition section may be configured to cover both of the part of the electric current lead at and above the thermal resistance section and the circumferential side of the cooling section of the cooling unit.

Further, the thermal resistance section may be formed by coupling conductors or by partly reducing the cross-sectional area of the electric current lead to a smaller value than the other part or by interposing a conductive material having a thermal resistance higher than the other part of the electric current lead. In any case, the thermal resistance section can have increased thermal resistance and produce a significant temperature difference between the parts across it. This enables shielding the cooling section of the cooling unit more effectively from the coolant gas heated by the leaked heat, which results in further effective cooling.

### BRIEF DESCRIPTION OF DRAWINGS

FIG. 1 This is a cross sectional view of a cryostat according to a first embodiment of the present invention taken along a vertical plane.

FIG. 2 This is a graph illustrating temperature distribution in an electric current lead in a vertical direction.

FIG. 3 This is a table of the thermal resistance and the thermal resistance per unit length of an electric current lead at some points in the vertical direction.

FIG. 4A This is a schematic view of a cryostat with no thermal resistance section of an electric current lead.

FIG. 4B This is a schematic view of a cryostat with a thermal resistance section of an electric current lead that is located at a level lower than the lower end of a partition section.

FIG. 4C This is a schematic view of the same cryostat as in FIG. 1, illustrating the influence of each leaked heat.

FIG. 5 This is a cross sectional view of a cryostat according to a second embodiment of the present invention taken along a vertical plane.

FIG. 6A This is a schematic view of a cryostat in which a thermal resistance section of an electric current lead is located at a level lower than the lower end of a partition section for a refrigerator, and the lower end of a partition section for the electric current lead is located at a level higher than the thermal resistance section.

FIG. 6B This is a schematic view of the same cryostat as in FIG. 5, illustrating the influence of each leaked heat.

FIG. 7 This is a table of the amount of heat leaked in the cryostat of FIG. 1, FIG. 5 or FIG. 6A, determined by applying an electricity to the electric current lead and measuring the temperature of the electric current lead at several points.

FIG. 8A This illustrates another example of a thermal resistance section that is formed by interposing a material having a high thermal resistance between the conductors of an electric current lead.

FIG. 8B This illustrates another example of a thermal resistance section that is formed by partly reducing the sectional area of a conductor of an electric lead.

### DESCRIPTION OF EMBODIMENTS

### First Embodiment

Hereinafter, a first embodiment of the present invention will be described in detail referring to the drawings.

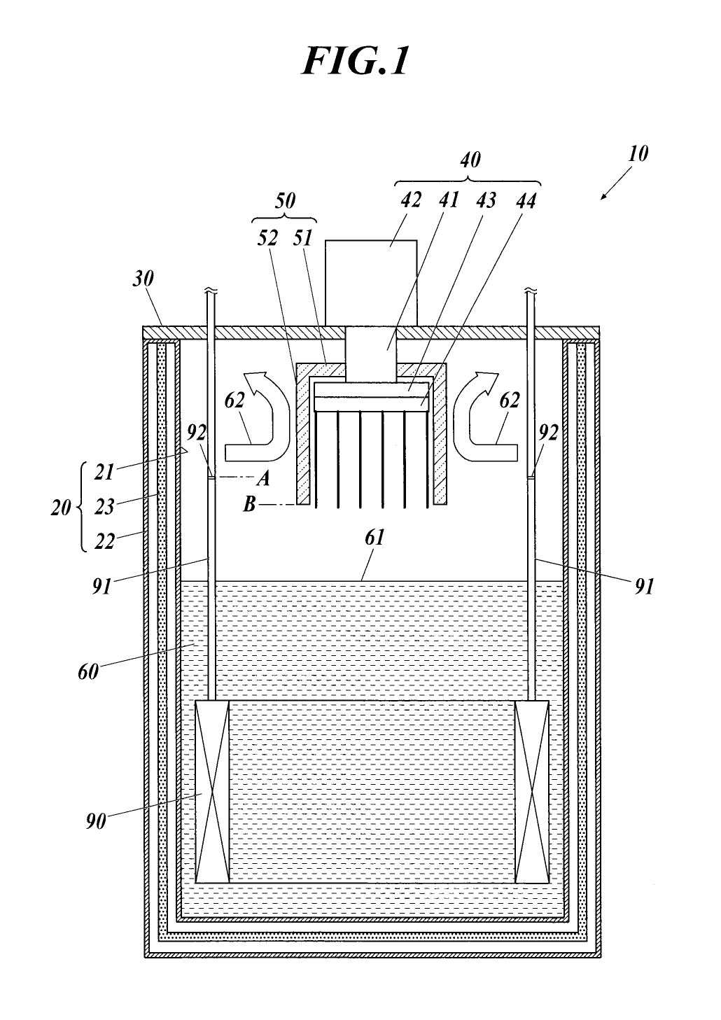

The first embodiment is a cryostat 10, which is a cooling container to house and cool a superconducting coil 90 as a superconductive equipment to be cooled. FIG. 1 is a cross sectional view of the cryostat 10 taken along a vertical plane.

The cryostat 10 includes an inner container 21 and an outer container 22 that are vacuum-insulated from each other. The cryostat 10 further includes a coolant container 20 to house liquid nitrogen 60 as a liquid coolant and a superconducting coil 90, a lid member 30 capable of covering an upper opening the coolant container 20, a refrigerator 40 as a cooling unit to cool the liquid nitrogen 60 in the inner container 21, a partition section 50 to shield the circumferential side and the upper side of a cooling section (described later) of the refrigerator 40 from convecting coolant gas, and a pair of electric current leads 91, 91 to apply an electricity to the superconducting coil 90 from the outside of the cryostat 10. Each phase of the superconducting coil 90 is provided with a pair of electric current leads 91, 91.

Coolant Container

The coolant container 20 is a double-walled bottomed container including the inner container 21 and the outer container 22 that are vacuum-insulated from each other.

The inner container 21 has a vertically cylindrical shape with a closed lower end as the bottom and an open upper end.

As with the inner container 21, the outer container 22 has a vertically cylindrical shape with a closed lower end as the bottom and an open upper end. The outer container 22 is slightly larger than the inner container 21 and houses the inner case 21 therein. Furthermore, the inner container 21 and the outer container 22 are integrally joined to each other at the respective upper ends so that an interspace is formed between the outer circumferential side and the outer bottom of the inner container 21 and the inner circumferential side and the inner bottom of the outer container 22. The interspace between the inner container 21 and the outer container 22 is vacuumed so that they are vacuum-insulated from each other.

Further, a super insulation material 23, which is constituted by a laminate of aluminum-deposited polyester films, is provided over the whole cylindrical part and the bottom part of the interspace between the inner container 21 and the outer container 22 in order to shield the inside from external radiation heat.

Lid Member

The joining part between the inner container 21 and the outer container 22 (the upper end face of the coolant container 20) is formed in a flat shape, and a disk lid member 30 is mounted on this ring flat face (upper end face).

The lid member 30 is mounted detachably from the coolant container 20 so that the inner space of the coolant container 20 is accessible for maintenance. The lid member 30 is fixed on the coolant container 20 by a well-known technique in the art, for example, by means of a fitting structure between the lid member 30 and the coolant container 20 or by means of bolts.

Since the lid member 30 supports the refrigerator 40 and the electric current leads 91, 91 that hang down from the lid member 30, it is preferably made of a material that can impart sufficient strength as the support. Specifically, the lid member 30 may be made of FRP (fiber reinforced plastic), stainless steel, etc.

Superconducting Coil

As the superconductive equipment, the super conductive coil 90 is housed in the inner space of the inner container 21. Further, the two electric current leads 91, 91, which are connected to the superconducting coil 90, vertically penetrate the lid member 30 and are fixed thereon. Each of the electric current leads 91, 91 is connected to a power supply (not shown) for the superconducting coil 90 at one end and is connected to a cable from the superconducting coil 90 in the coolant container 20 at the other end. Further, each of the electric current leads 91, 91 includes an insulation coating of epoxy resin or the like on the surface. Since the electric current leads 91, 91 are closely fitted on the lid member 30 via the coating, it is possible to take the superconducting coil 90 out of the coolant container 20 through the electric current leads 91, 91 by dismounting the lid member 30 from the coolant container 20. In this way, the maintenance of the superconducting coil 90 can be performed easily.

Electric Current Lead

The electric current leads 91, 91 are constituted by conductive metal rods (e.g. copper), in which thermal resistance sections 92, 92 having a thermal resistance higher than the other part are formed at a level higher than a prescribed liquid level 61. This liquid level 61 is a liquid level of the liquid nitrogen 60 when a prescribed amount of the liquid nitrogen 60 is stored in the inner container 21. The two electric current leads 91, 91 have the same structure, and the respective thermal resistance sections 92, 92 are formed at the same level. Accordingly, only one of them will be described.

The electric current lead 91 is configured such that two metal rod bodies having the same diameter are coupled with each other by means of clamping with bolts or the like so that the respective ends abut each other. Since the two metal rod bodies are thus coupled with each other, the coupling part exhibits a thermal resistance higher than the other part of the rod bodies. This property allows the coupling part to serve as the thermal resistance section 92.

Further, since each of the electric current leads 91, 91 is held such that the two metal rod bodies abut each other at the respective ends, electric connection between the two metal rod bodies is ensured.

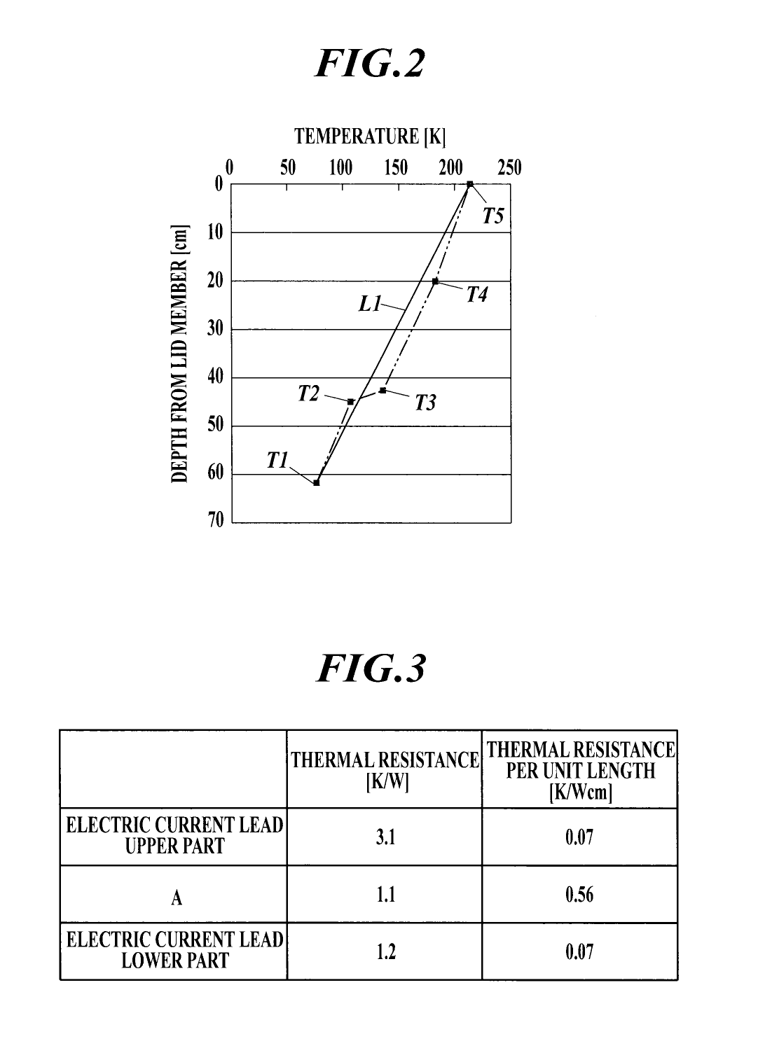

FIG. 2 is a graph showing the temperature distribution of the electric current lead 91 measured at several points in the vertical direction. To determine the temperature distribution in the graph, the temperature of the electric current lead 91 was measured at the liquid level of the liquid nitrogen 60 (temperature T1), below and near the thermal resistance section 92 (temperature T2), above and near the thermal resistance section 92 (temperature T3), at the midpoint between the thermal resistance section 92 and the lid member 30 (temperature T4) and below and near the lid member 30 (temperature T5). In FIG. 2, the chain double-dashed line is the temperature distribution when the thermal resistance section 92 is provided in the electric current lead 91, and the solid line L1 is the temperature distribution when the thermal resistance section 92 is not provided in the electric current lead 91.

FIG. 3 shows the thermal resistance and the thermal resistance per unit length of the electric current lead 91 at several parts in the vertical direction. In the table, the “electric current lead upper part” refers to the part of the electric current lead 91 from above the thermal resistance section 92 to the lid member 30, the “thermal resistance section” refers to the part from the lower end to the upper end of the thermal resistance section 92, and the “electric current lead lower part” refers to the part of the electric current lead 91 from the liquid level 61 to below the thermal resistance section 92.

In the measurement, no electric current is applied to the electric current lead 91, and a heat leaked from the outside of the coolant container 20 is the only heat source.

As shown in FIG. 3, the electric current lead 91 exhibits approximately the same thermal resistance per unit length between the part above the thermal resistance section 92 and the part below the thermal resistance section 92, while it exhibits a significantly higher thermal resistance per unit length at the thermal resistance section 92.

When the electric current lead 91 does not include the thermal resistance section 92 and has a uniform thermal resistance per unit length, it exhibits the temperature distribution as shown by the solid line L1 in FIG. 2, in which the temperature decreases in an approximately proportional manner toward the lower end and reaches the temperature of the liquid nitrogen at the lower end. In contrast, when the thermal resistance section 92 is provided, the heat leaked from the upper end of the electric current lead 91 is less conductive to the thermal resistance section 92 and the part therebelow as illustrated by the chain double-dashed line in FIG. 2. As a result, the temperature at the whole part above the thermal resistance section 92 becomes higher with respect to the L1, while the temperature at the whole part below the thermal resistance section 92 becomes lower with respect to the L1.

That is, the electric current lead 91 can produce a significant temperature difference across the thermal resistance section 92, in which the whole side close to a heat source has a high temperature while the whole side away from the heat source has a low temperature.

Since the heat leaked through the electric current lead 91 is transferred to the surroundings by convection of the coolant (nitrogen) gas in the inner container 21, a significant temperature difference is also produced in the atmosphere between the areas in the inner container 21 below and above the thermal resistance section 92.

Refrigerator

The refrigerator 40 is a so-called GM refrigerator using a regenerating material. The refrigerator 40 includes a cylinder section 41 that allows vertical reciprocation of a displacer container containing a regenerating material, a drive section 42 that houses a crank mechanism driven by a motor to vertically reciprocate the displacer container, and a heat exchanger 44 that serves as a heat exchanging member and is provided in a cryo-transfer section 43 where the temperature is the lowest in the cylinder section 41.

The refrigerator 40 is connected to a compressor and the like (not shown) so that coolant gas is pumped to and from the inner space of the refrigerator 40.

In the refrigerator 40, the drive section 42 is attached on the upper face of the lid member 30, and the cylinder section 41 penetrates the lid member 30 to hang down in the coolant container 20.

In the inner space of the cylinder section 41, the coolant gas is adiabatically compressed and heat is absorbed while it is falling down, and thereby the lower end of the cylinder section 41 becomes the coolest.

The cryo-transfer section 43 is formed on the lower end of the cylinder 41, i.e. at the coolest portion. The cryo-transfer section 43, which is formed in a flat circular plate shape having an area of the base larger than the bottom part of the cylinder section 41, is provided to enhance the heat conductivity to the surroundings.

The heat exchanger 44 is made of a material having a heat conductivity similar to or higher than the cryo-transfer section 43. The heat exchanger 44 is in close contact with the bottom of the cryo-transfer section 43 at the upper part and includes a plurality of fins extending downward from the lower part. This structure increases the contact area of the heat exchanger 44 with the surrounding nitrogen gas (coolant gas) to further enhance the heat conductivity to the coolant gas, and thereby brings high performance of cooling the coolant gas.

In this way, the cryo-transfer section 43 and the heat exchanger 44 serve as the cooling section of the refrigerator 40.

Partition Section

The partition section 50 is fixedly supported by the cylinder section 41 of the refrigerator 40 in the coolant container 20. The partition section 50 surrounds the cryo-transfer section 43 and the heat exchanger 44, namely the cooling section, to shield them from the coolant gas in all directions except the bottom.

The partition section 50 includes a top plate 51 that penetrates the cylinder section 41 and is fixed thereon and a cylindrical side wall 52. The top plate 51 is integrally joined to the side wall 52 so as to close the upper end of the side wall 52. Further, the side wall 50 is made of a material that has a heat conductivity lower than the cryo-transfer section 43 and the heat exchanger 44, for example, stainless steel, or a low-temperature resistant heat insulating material such as FRP, glass wool and urethane foam.

The outer diameter of the top plate 51 of the partition section 50 is slightly larger than the cryo-transfer section 43. The top plate 51 is fixed on the cylinder section 41 such that it leaves a clearance with the upper face of the cyro-transfer section 43 so as not to be in contact with the upper face, or that it has a minimal contact area even if it is in contact with the upper face. In terms of preventing heat leak from the partition section to the cryo-transfer section, it is preferred to leave a clearance between the top plate 51 and the cryo-transfer section 43 so that they are not in contact with each other.

The side wall 52 is formed in a cylindrical shape to surround the cryo-transfer section 43 and the heat exchanger 44, namely the cooling section of the refrigerator 40. The side wall 52 is integrally joined onto the lower face of the top plate 51 at the upper end and is open at the lower end. The inner diameter of the side wall 52 is slightly larger than the outer diameter of the cryo-transfer section 43 and the heat exchanger 44, and the side wall 52 surrounds them without contact with them.

Further, the side wall 52 extends downward to approximately the same level as the lower end of the fins of the heat exchanger 44. In this way, the partition section 50 surrounds the cooling section of the refrigerator 40 so as to prevent the cooling section from being exposed to convection of the surrounding nitrogen gas. Therefore, the refrigerator 40 can cool the liquid nitrogen with high efficiency.

Relationship Between Thermal Resistance Section and Partition Section

The relationship between the above-described thermal resistance section 92 and the partition section 50 will be described.

In FIG. 1, “A” is the level of the thermal resistance section 92, and “B” is the level of the lower end of the side wall 52 of the partition section 50.

As illustrated in the figure, the lower end of the side wall 52 of the partition section 50 extends to a level lower than the thermal resistance section 92 (to a level closer to the liquid level 61 of the liquid nitrogen 60). (The positional relationship between the thermal resistance section 92 and the lower end of the side wall 52 is referred to as “A>B”.)

Considering the thickness in the vertical direction of the thermal resistance section 92, the lower end of the side wall 52 of the partition section 50 extends at least to a level lower than the upper end of the thermal resistance section 92, more desirably to a level lower than the lower end of the thermal resistance section 92.

As described above, compared to the case with no thermal resistance section 92, the temperature of each electric current lead 91 becomes higher at the whole part above the thermal resistance section 92 and lower at the whole part below the thermal resistance section 92. Accordingly, the temperature of the inner space of the container 21 becomes higher at the whole area above the thermal resistance section 92 due to convection of the nitrogen gas, and the temperature of the area below the thermal resistance section 92 becomes lower than the upper area by a significant difference.

Since the lower end of the side wall 52 extends to a level lower than the thermal resistance section 92, the partition section 50 can shield the cooling section of the refrigerator 40 from the convection of the nitrogen gas 62 that occurs in the area above the thermal resistance section 92. This can reduce the required cooling performance by the amount required for cooling the heated coolant gas to a temperature near the boiling point thereof, which was heated by the heat leaked into the inner space of the cooling container 20 through the electric current leads 91.

Meanwhile, the heat leaked through the electric current leads 91 is less conducted to the part of each electric current lead 91 below the thermal resistance section 92, and the leaked heat causes a smaller rise in temperature of the nitrogen gas in the area below the thermal resistance section 92, which maintains the area at a low temperature. This low-temperature nitrogen gas is cooled and re-liquefied by the cooling section of the refrigerator 40 inside the partition section 50. Therefore, the cryostat 10 can perform cooling and re-liquefaction of the coolant with high efficiency.

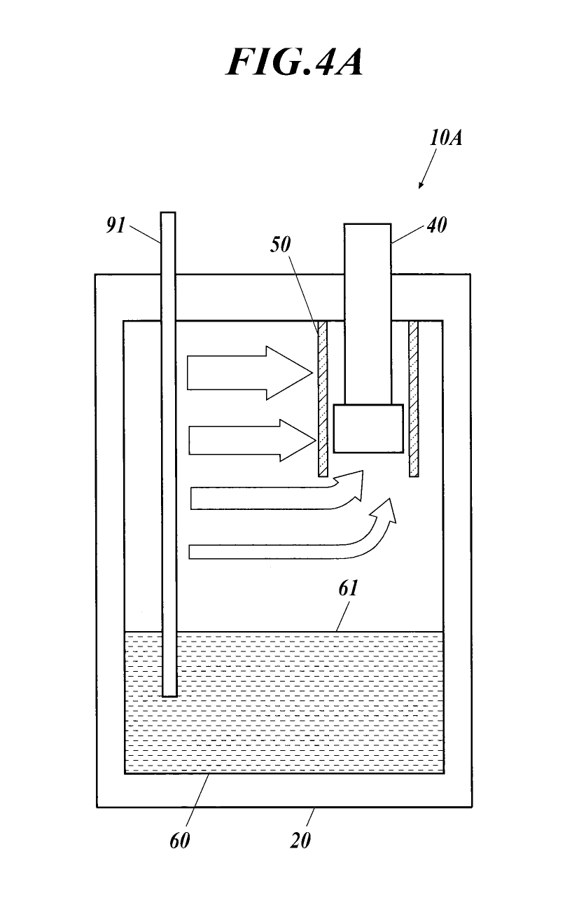

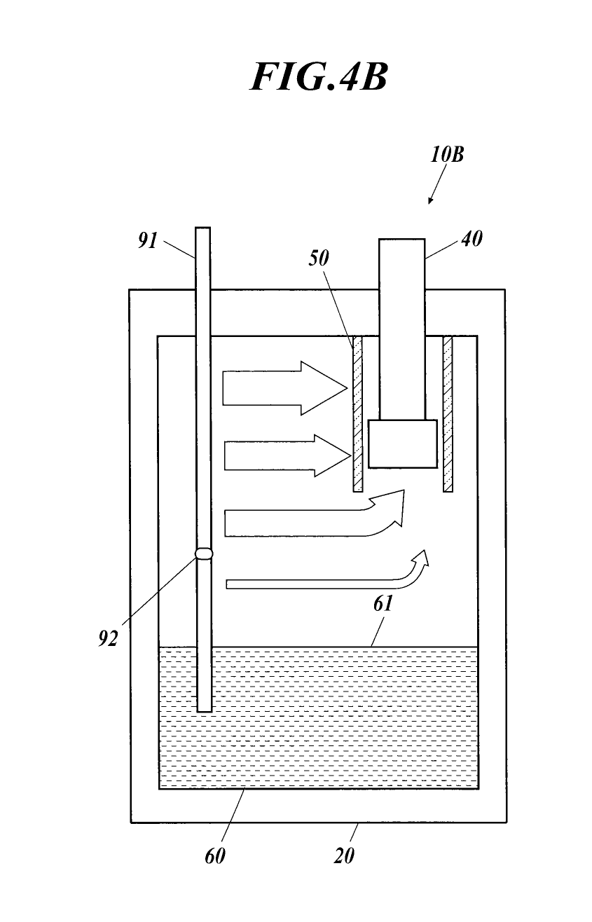

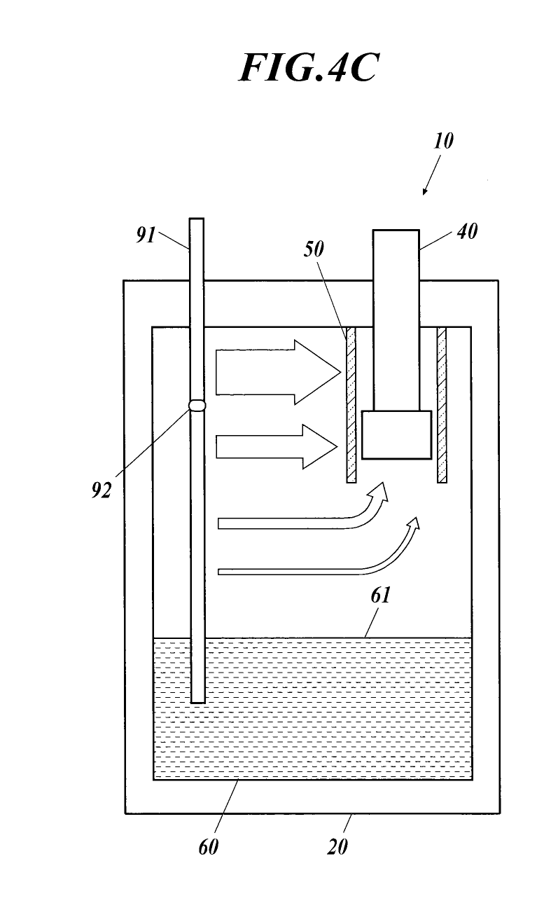

With FIG. 4A to FIG. 4C, the influence of the heat of the coolant gas will be described comparing the above-described cryostat 10 with cryostats 10A and 10B, which are examples for comparison. FIG. 4A to FIG. 4C are schematic illustration of the configurations. FIG. 4A illustrates the cryostat 10A in which no thermal resistance section 92 is provided in each electric current lead 91. FIG. 4B illustrates the cryostat 10B in which a thermal resistance section 92 of each electric current lead 91 is provided at a level lower than the lower end of the partition section 50. FIG. 4C illustrates the above-described cryostat 10. In FIG. 4A to 4C, each arrow shows convection of the coolant (nitrogen) gas, and the thickness of each arrow represents the amount of heat of the nitrogen gas.

In the case of the cryostat 10A, since no thermal resistance section 92 is provided in each electric current lead 91, a heat leaked through the electric current leads 91 is conducted to the lower end, which increases the amount of heat conducted to the nitrogen gas in the area lower than the partition section 50. This requires the cooling section of the refrigerator 40 to cool and re-liquefy the nitrogen gas heated by the leaked heat, and therefore results in the deteriorated cooling efficiency.

In the case of the cryostat 10B, a heat leaked through the electric current leads 91 is sufficiently conducted to the thermal resistance section 92 of each electric current lead 91, and a large amount of heat is conducted to the nitrogen gas in the area below the partition section 50. This requires the cooling section of the refrigerator 40 to cool and re-liquefy the nitrogen gas heated by the leaked heat, and therefore results in the deteriorated cooling efficiency.

In the case of the cryostat 10, a heat leaked through the electric current leads 91 is sufficiently conducted to the thermal resistance section 92 of each electric current lead 91. However, a reduced amount of leaked heat is conducted to the part below the thermal resistance section 92, which reduces the amount of heat conducted to the nitrogen gas in the area below the partition section 50. This allows the cooling section of the refrigerator 40 to cool and re-liquefy the nitrogen gas that is less affected by the leaked heat, and therefore improves the cooling efficiency.

### Second Embodiment

Hereinafter, a second embodiment of the present invention will be described in detail referring to the drawings.

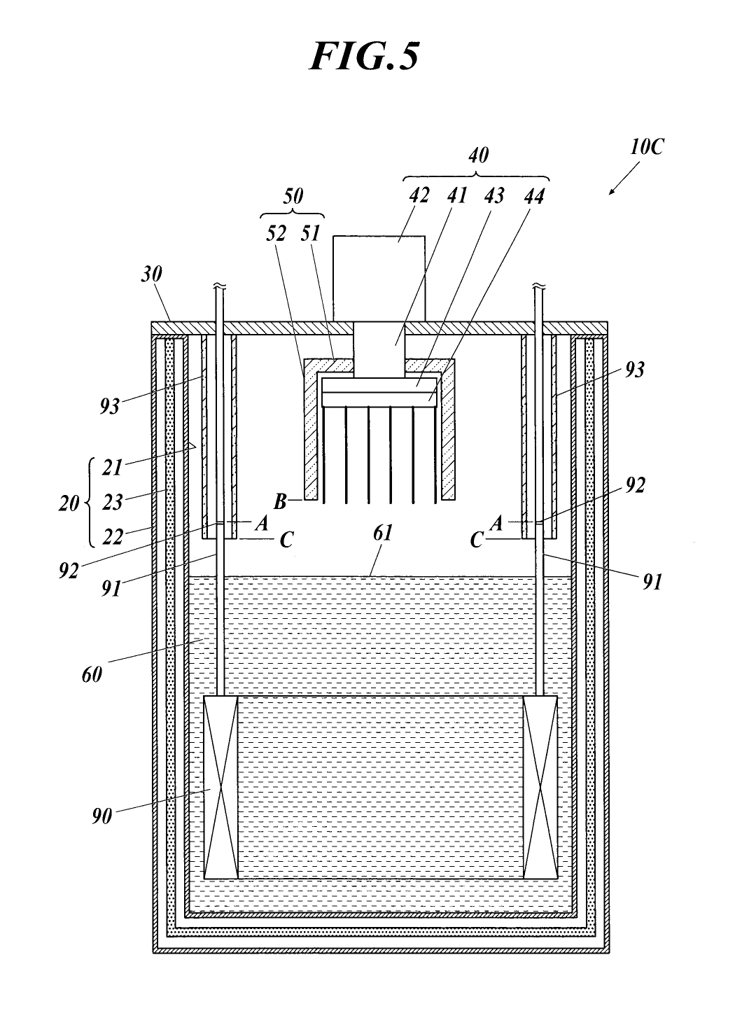

FIG. 5 is a cross sectional view of a cryostat 10C of the second embodiment taken along a vertical plane.

The cryostat 10C differs from the cryostat 10 in that it further includes partition sections 93 that surround respective electric current leads 91. Hereinafter, only the features of the cryostat 10C that are different from those of the cryostat 10 will be described, while the same reference signs are denoted to the same components and repetitive description is omitted.

As described above, each electric current lead 91 is provided with a partition section 93 that surrounds the electric current lead 91.

The partition section 93 is constituted by a tube of a heat insulating material in which the respective electric current leads 91 are loosely inserted. The partition section 93 is attached on the lower face of a lid member 30 at the upper end and fixedly hangs down therefrom.

The partition section 93 is made of a heat insulating material, for example, FRP, glass wool, foamed urethane or the like that is resistant to low-temperature.

Further, the lower end of the partition section 93 is located at a level lower than the thermal resistance section 92 of each electric current lead 91 but higher than a liquid level 61 of liquid nitrogen 60. That is, when the level of the thermal resistance section 92 and the level of the lower end of the partition section 93 in FIG. 5 are denoted as “A” and “C” respectively, the positional relationship is represented as A>C.

Also in this case, considering the thickness in the vertical direction of the thermal resistance section 92, the lower end of the partition section 93 is located at a level at least lower than the upper end of the thermal resistance section 92, and more desirably it extends to a level lower than the lower end of the thermal resistance section 92.

As described above, the temperature of each electric current lead 91 is high at the part above the thermal resistance section 92 because a heat leaked from the outside is conductive thereto, while the temperature is maintained at a low level at the part below the thermal resistance section 92 because the leaked heat is less conductive thereto.

Accordingly, the leaked heat heats the nitrogen gas around the part of each electric current lead 91 above the thermal resistance section 92 to raise the temperature of the area. However, the partition section 93 that surrounds the area around the thermal resistance section 92 prevents the heat from being conducted to the nitrogen gas outside the partition wall 93 due to convection.

In contrast, the part of each electric current lead 91 below the lower end of the partition section 93 is not surrounded by the partition section 93. However, since the thermal resistance section 92 reduces the amount of leaked heat conducted to the part, the nitrogen gas around the part below the lower end of the partition section 93 is less affected by the leaked heat.

Therefore, the cooling section of the refrigerator 40 is less affected by the high-temperature nitrogen gas above the thermal resistance section 92, and cools and re-liquefies the low-temperature nitrogen gas below the thermal resistance section 92. As a result, the cryostat 10C can perform cooling and re-liquefaction of the coolant with high efficiency.

In the cryostat 10C, since the lower end of the partition section 93 of each electric current lead 91 is located at a level lower than the thermal resistance section 92, it is possible to dispose the thermal resistance section 92 at a level lower than the lower end of the partition section 50 as illustrated in FIG. 5.

Further, since each electric current lead 91 is provided with the partition section 93, it is also possible to omit the partition section 50 that is provided on the cooling section of the refrigerator 40. Also in this case, the cryostat can perform cooling and re-liquefaction of the coolant with high efficiency compared to a cryostat that includes neither the partition wall 50 nor the partition wall 93.

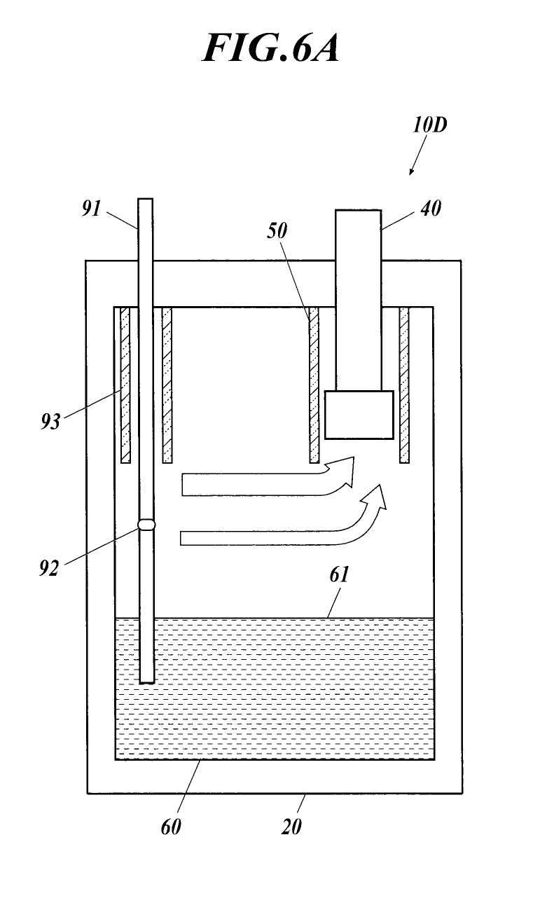

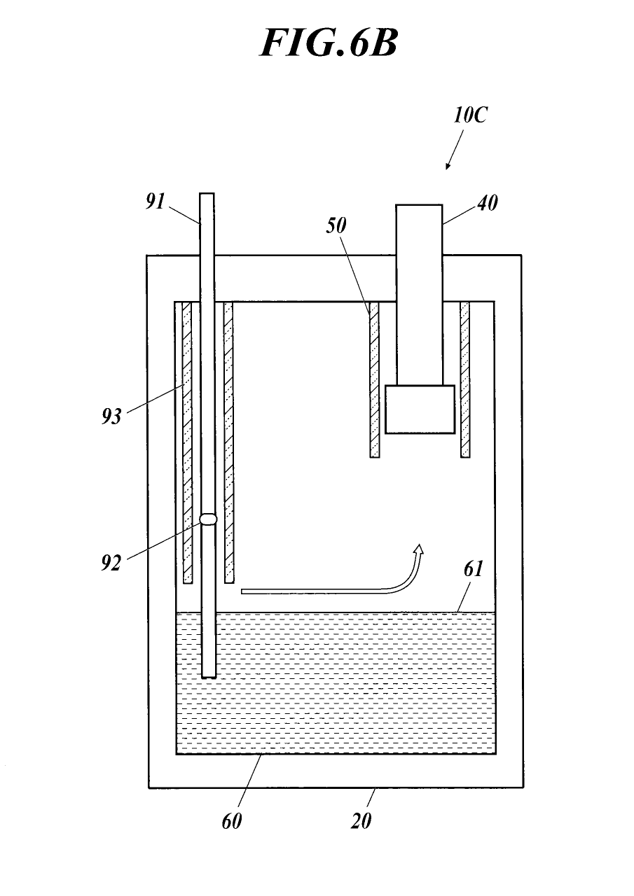

With FIG. 6A and FIG. 6B, the influence of heat will be described comparing the above-described cryostat 10C with a cryostat 10D, which is an example for comparison. FIG. 6A and FIG. 6B are schematic illustration of the configurations. FIG. 6A illustrates the cryostat 10D in which the thermal resistance section 92 of each electric current lead 91 is located at a level lower than the lower end of the partition section 50 of the refrigerator 40, and the lower end of the partition section 93 of each electric current lead 91 is located at a level higher than the thermal resistance section 92. FIG. 6B illustrates the above-described cryostat 10C.

In the case of cryostat 10D, a leaked heat is conducted through the electric current leads 91 to the part of each electric current lead 91 above the thermal resistance section 92. Since the part above the thermal resistance section 92 is only partly surrounded by the partition section 93, a large amount of heat is conducted to the nitrogen gas in the area below the partition section 50 due to convection. This requires the cooling section of the refrigerator 40 to cool and re-liquefy the nitrogen gas heated by the leaked heat, and therefore deteriorates the cooling efficiency.

In the case of the cryostat 10C, a leaked heat is conducted through the electric current leads 91 to the part of each electric current lead 91 above the thermal resistance section 92. However, since the partition section 93 fully surrounds the part above the thermal resistance section 92, it prevents convection itself of the heated nitrogen gas and thereby reduces the amount of heat conducted to the nitrogen gas in the area below the partition section 50. This allows the cooling section of the refrigerator 40 to cool and re-liquefy nitrogen gas that is less affected by the leaked heat, and therefore improves the cooling efficiency.

Comparative Test

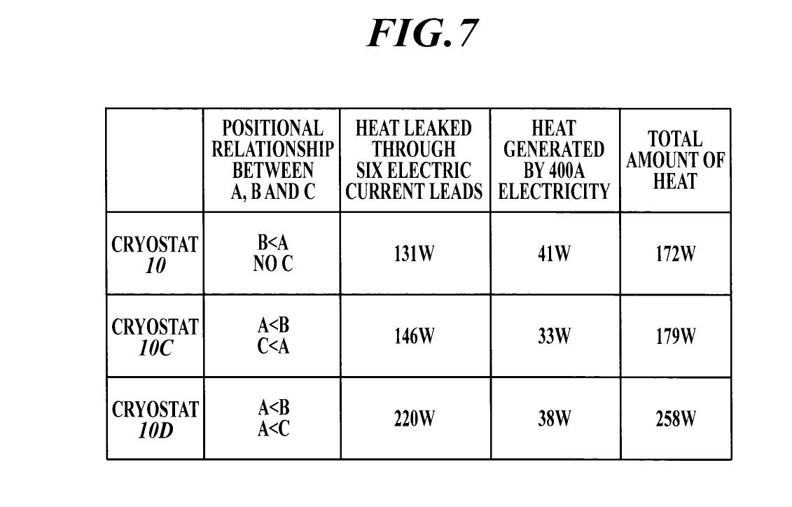

FIG. 7 is a table of the amount of heat leaked in the above-described cryostat 10, 10C or 10D, each determined by applying a 400A electricity to three pairs (six in total) of the electric current leads 91 and measuring the temperature of the electric current leads 91 at a plurality of points.

The “leaked heat” in FIG. 7 is calculated from the surface temperatures measured at four points on the electric current leads 91, namely a point below and near the lid member 30, a midpoint between the lid member 30 and the thermal resistance section 92, a point above and near the thermal resistance section 92, and a point below and near the thermal resistance section 92.

The “generated heat” in FIG. 7 is the amount of heat determined by measuring the voltage across a pair of electric current leads 91, 91 when an electricity of 400 A is applied to the electric current leads 91 and calculating the amount of heat from the current and the voltage.

The “total amount of heat” in FIG. 7 is the sum of the above-described “leaked heat” and the “generated heat”.

Regarding the positional relationship of A, B and C, “A” is the level of each thermal resistance section 92, “B” is the level of the lower end of the partition section 50 of the refrigerator 40, and “C” is the level of the lower end of the partition section 93 of each electric current lead 91.

In the cryostat 10, the level A of each thermal resistance section 92 is higher than the level B of the lower end of the partition section 50 of the refrigerator 40, and each electric current lead 91 is not provided with the partition section 93 (see FIG. 4C).

In cryostat 10C, the level A of each thermal resistance section 92 is lower than the level B of the lower end of the partition section 50 of the refrigerator 40, and the level C of the lower end of the partition section 93 of each electric current lead 91 is lower than the level A of each thermal resistance section 92 (see FIG. 6B).

In cryostat 10D, the level A of each thermal resistance section 92 is lower than the level B of the lower end of the partition section 50 of the refrigerator 40, and the level C of the lower end of the partition section 93 of each electric lead 91 is higher than the level A of each thermal resistance section 92 (see FIG. 6A).

The cryostats 10, 10C and 10D were compared to each other in terms of leaked heat, and it was observed that the cryostat 10 and 10C exhibited a reduced leaked heat while the cryostat 10D exhibited a leaked heat significantly higher than the other two.

Other Configurations of Thermal Resistance Section

The structure of the thermal resistance section provided in each electric current lead 91 is not limited to that of the above-described thermal resistance section 92 but may be any other structure that ensures electrical connection between the parts above and below the thermal resistance section and that has a thermal resistance per unit length in the vertical direction higher than at least the part thereabove, and more preferably also higher than the part therebelow.

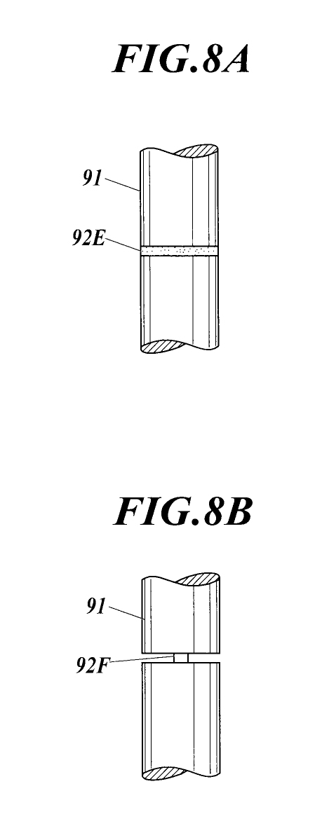

For example, FIG. 8A illustrates a thermal resistance section 92E that is formed by interposing a material between a metal (e.g. copper) rod bodies of an electric current lead 91, in which the material is electrically conductive and has a thermal resistance higher than the metal (copper) of the metal rod bodies.

Further, FIG. 8B illustrates a thermal resistance section 92F that has a cross sectional area smaller than the other part, which is formed by partly reducing the outer diameter of an electric current lead 91.

As with the thermal resistance section 92, the thermal resistance sections 92E and 92F can also produce a certain temperature difference between the parts above and below them, so as to exert the same advantageous effect as the thermal resistance section 92.

Others

The partition sections 50 and 93 surround the cooling section of the refrigerator 40 and each electric current lead 91 respectively. Instead of them, a partition plate or a partition wall may be provided to interrupt convection of the nitrogen gas from the thermal resistance section 92 of each electric current lead 91 to the cooling section of the refrigerator 40. In this case, it is desirable that at the upper end and both side ends of the partition plate (wall) are in close contact with the lower face of the lid member 30 and the inner face of the inner container 21 respectively so as to prevent wraparound of the convection. It is also desirable that the lower end of the partition plate (wall) is located at a level at least lower than the thermal resistance section 92.

In the example in FIG. 5, the level A of the thermal resistance section 92, the level B of the lower end of the partition section 50 of the refrigerator 40 and the level C of the lower end of the partition wall 93 of each electric current lead 91 have the relationships B>A and A>C. However, the level B may be changed as long as at least the condition A>C is satisfied. For example, they may have the relationship A>C>B.

Further, in the above examples, the thermal resistance sections 92, 92 of the two electric leads 91, 91 have the same height. However, the thermal resistance sections 92, 92 do not necessarily have the same height as long as they are at least provided to the part of the respective electric current leads 91, 91 where a predetermined condition is satisfied (e.g. A>B in the example in FIG. 1, or at least A>C, desirably B>A>C in the example in FIG. 5).

Further, the lid member 30 may have a hollow structure, and the evacuated inner space may impart heat insulation property. Furthermore, a super insulation material may be housed in the hollow inner space.

Further, the partition wall 50 may not have the top plate 51, and the side wall 52 may be extended upward and be directly attached on the lower face of the lid member 30.

### INDUSTRIAL APPLICABILITY

The present invention is applicable to the fields in which a superconducting wire or a superconducting film is cooled to an ultralow temperature with high efficiency in order to make it superconductive.

### DESCRIPTION OF REFERENCE NUMERALS

10, 10C cryostat
20 coolant container
21 inner container
22 outer container
30 lid member
40 refrigerator (cooling unit)
43 cryo-transfer section (cooling section)
44 heat exchanging section (cooling section)
50 partition section
60 liquid nitrogen
90 superconducting coil (object to be cooled)
91 electric current lead
92, 92E, 92F thermal resistance section
93 partition section

1. A cooling container, comprising:
a coolant container which houses an object to be cooled and a liquid coolant in an inner space;
a lid member capable of closing an upper opening of the coolant container;
a cooling unit which is supported by and hung from the lid member and which comprises a cooling section at a lower end; and
an electric current lead which is supported by and hung from the lid member, and which applies an electric current to the object to be cooled in the inner space of the coolant container,
wherein the electric current lead comprises a thermal resistance section which is disposed in the inner space of the coolant container at a level higher than a liquid level of the liquid coolant, and which has a thermal resistance higher than parts of the electric current lead above and below the thermal resistance section, and
wherein a cooling container further comprises a partition section which is made of a heat insulating material, and which is disposed between the thermal resistance section and the cooling section of the cooling unit, in which a lower end of the partition section extends to a level lower than the thermal resistance section.

2. The cooling container according to claim 1, wherein the partition section covers a circumferential side of the thermal resistance section of the electric current lead and a part above the thermal resistance section.

3. The cooling container according to claim 1, wherein the partition section covers a circumferential side of the cooling section of the cooling unit.

4. The cooling container according to claim 1, wherein the thermal resistance section is constituted by a structure which has a reduced cross sectional area compared to the other part of the electric current lead.

5. The cooling container according to claim 1, wherein the thermal resistance section is constituted by a portion in which separate conductor bodies are coupled with each other.

6. The cooling container according to claim 1, wherein the thermal resistance section is constituted by a structure in which a conductive material having a thermal resistance higher than the other part of the electric current lead is interposed in the electric current lead.
